(19) United States
(12) Patent Application Publication
(10) Pub. No.: US 2021/0035120 A1
(43) Pub. Date: Feb. 4, 2021

(54) ADAPTIVE AND VERIFIABLE BILL OF MATERIALS

(71) Applicant: EMC IP Holding Company LLC, Hopkinton, MA (US)

(72) Inventors: Brian C. Mullins, Burlington, MA (US); Riaz Zolfonoon, Concord, MA (US)

(21) Appl. No.: 16/527,662

(22) Filed: Jul. 31, 2019

(51) Int. Cl. G06Q 30/00; H04L 9/32; H04L 9/30

(52) U.S. Cl. CPC G06Q 30/0185; H04L 9/3247; G06Q 2220/00; H04L 2209/38; H04L 9/30

(57) ABSTRACT

Techniques are provided for producing adaptive and verifiable bills of materials. One method comprises obtaining a verifiable claim associated with a device issued by a supplier of the device, wherein the verifiable claim comprises a decentralized identity for the device with corresponding public attributes; and verifying the verifiable claim for the device using the decentralized identity for the verifiable claim and the corresponding public attributes obtained from a distributed ledger. The verifying comprises, for example, reading a public key from the distributed ledger and verifying a digital signature of the verifiable claim using the public key. The verifiable claim for a given part may comprise a part status and when the part status of the given part indicates a recalled status, one or more predefined recall policies are applied for the given part and/or a device comprising the given part.

### FIELD

The field relates generally to a verification of one or more parts within an end product.

### BACKGROUND

A typical device comprises many parts, often manufactured by multiple suppliers in a supply chain. It can often be important to have a high level of assurance that one or more safety-critical components of the device are genuine parts as specified by the manufacturer, and/or defect free.

A bill of materials (BOM) is a list of the component parts and/or sub-assemblies of an end product. A need exists for techniques for creating a verifiable BOM for a product. A further need exists for a secure method for updating a BOM to capture changes to a given product.

### SUMMARY

In one embodiment, a method comprises obtaining at least one verifiable claim associated with a device issued by at least one supplier of the device, wherein the at least one verifiable claim comprises a decentralized identity for the device with one or more corresponding public attributes; and verifying the at least one verifiable claim for the device using the decentralized identity for the at least one verifiable claim and one or more of the corresponding public attributes obtained from a distributed ledger.

In one or more embodiments, the verifying comprises reading a public key from the distributed ledger and verifying a digital signature of the verifiable claim using the public key. In some embodiments, the at least one verifiable claim for a given part comprises a part status and wherein the part status of the given part indicates a recalled status, and wherein one or more predefined recall policies are applied for one or more of the given part having the recalled status and a device comprising the given part having the recalled status.

Other illustrative embodiments include, without limitation, apparatus, systems, methods and computer program products comprising processor-readable storage media.

### BRIEF DESCRIPTION OF THE DRAWINGS

FIG. 1 illustrates an exemplary usage of verifiable claims according to a model from the World Wide Web Consortium;

FIG. 2 illustrates an exemplary part registration process for a part manufacturer (or a parts supplier) to verify one or more parts, according to an embodiment;

FIG. 3 is a flow chart illustrating an exemplary implementation of a verification process, according to at least one embodiment of the disclosure;

FIG. 4 is a flow chart illustrating an exemplary implementation of a part registry update process, according to some embodiments of the disclosure;

FIG. 5 is a flow chart illustrating an exemplary implementation of a device BOM update process, according to one or more embodiments

FIG. 6 illustrates an exemplary processing platform that may be used to implement at least a portion of one or more embodiments of the disclosure comprising a cloud infrastructure; and

FIG. 7 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for providing adaptive and verifiable bills of materials.

A decentralized identity (DID) is a digital identity that an entity creates, owns, and controls, without requiring the involvement of a centralized third party. DIDs can be associated with a person or a device. DIDs are backed by a public/private keypair. The public identifier and associated public attributes (e.g., a public key) are published to a public platform so that the information can be accessed by anyone, typically in the form of a distributed ledger (DLT), such as a blockchain. The DLT also provides assurances regarding data integrity. The private key is securely stored and kept private.

Verifiable claims (VCs) are cryptographically signed attestations which can be instantly verified by anyone. They can be issued by governments, banks, or even a friend or family member.

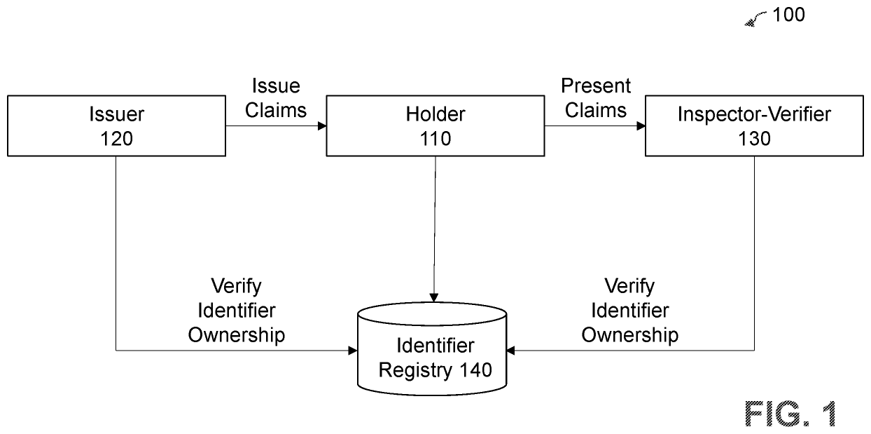

FIG. 1 illustrates an exemplary usage of verifiable claims according to a model 100 from the World Wide Web Consortium (W3C). In the example of FIG. 1, a holder 110 is an entity storing one or more verifiable claims (also known as a claims wallet). In addition, an issuer 120 generates claims and sends the generated claims to the holder 110 to store. An inspector-verifier 130 requests claims from the holder 110 to verify. Finally, an identifier registry 140 (e.g., a DLT) stores a mapping of identifiers (IDs) with their public attributes, such as public keys.

Generally, the issuer 120 issues claims that are then stored in one or more holders 110; and each holder 110 acquires, stores and/or presents claims to the inspector-verifier 130. In addition, the issuer 120 and the inspector-verifier 130 verify ownership of identifiers.

The classic example of a verifiable claim is a driver's license issued by, for example, a government entity, such as a Department of Motor Vehicles (DMV) (the issuer 120). The driver's license is stored by a person in their digital wallet app (the holder 110), which can then be presented to, for example, a bar (the inspector-verifier 130) to prove their age. If the inspector-verifier 130 (e.g., the bar) trusts the issuer 120 of the verifiable claim (e.g., the DMV) then they can trust the issued claim (in this case, the age of the person).

As noted above, a typical device comprises many parts manufactured by multiple suppliers in a supply chain. It can often be important to have a high level of assurance that the safety-critical components of the device are the genuine parts as defined by the manufacturer.

In one or more embodiments, a methodology is provided for creating an adaptive and verifiable device BOM. As discussed hereinafter, in various embodiments, the disclosed adaptive and verifiable device BOM methodology provisions, verifies, and/or recalls devices. In addition, the disclosed adaptive and verifiable device BOM methodology optionally allows a device to be securely updated.

Consider an exemplary use case where a car manufacturer, such as Tesla, wants to manufacture a vehicle whereby one or more critical parts of the device (e.g., motors, brakes, and/or battery pack) are required to be verifiable. The integrity of the vehicle could be then verified by stakeholders, such as the owner or a service center.

Device Provisioning

For a device manufacturer, such as Tesla, to manufacture a vehicle with verified parts, each verifiable part needs to be traceable back to its supplier and/or manufacturer. Suppliers can provide this information, for example, by assigning a DID to each part and registering the DIDs on a public DLT (or a private DLT). Each part that is registered on the DLT can include attributes including, but not limited to:
part serial number;
part creation date;
part provisioned date;
quality assurance data;
warranty expiration; and
part status (e.g., recalled)

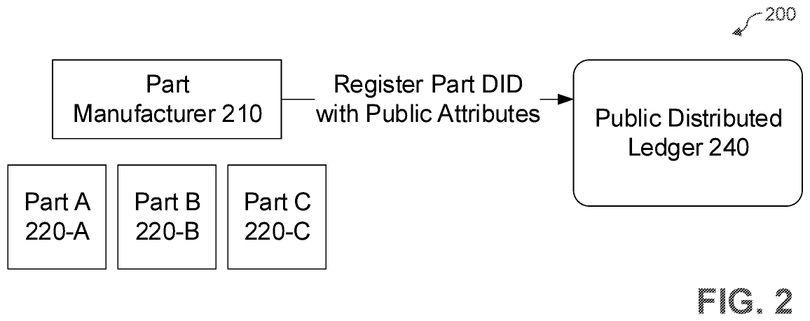

FIG. 2 illustrates an exemplary part registration process 200 for a part manufacturer 210 (or a parts supplier) to verify one or more parts 220-A through 220-C, according to an embodiment. As shown in FIG. 2, for each part 220-A through 220-C, the part manufacturer 210 registers a DID for the given part with corresponding public attributes (e.g., a public key) with a public distributed ledger 240 (e.g., the identifier registry 140 of FIG. 1).

Device Verification

Consider that when a device manufacturer, such as Tesla, sells the device, the prospective owner can cryptographically verify that the device came directly from the device manufacturer and that the critical components of the device are from trusted suppliers. Another common use case might be that a Tesla service center, for example, verifies the vehicle and its parts before performing services. For enterprises that own many devices (e.g., Uber, Hertz), a policy could be pushed down to each device that stipulates that a verification is performed at least once every 24 hours or on device start-up.

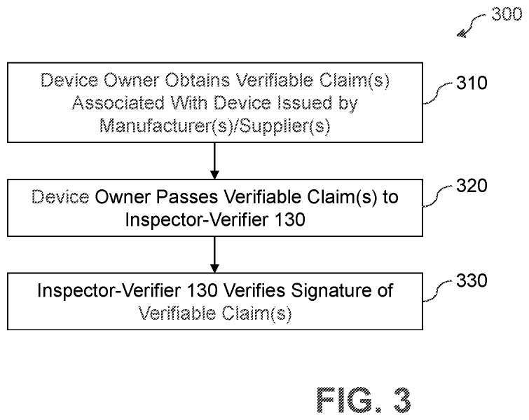

FIG. 3 is a flow chart illustrating an exemplary implementation of a verification process 300, according to at least one embodiment of the disclosure. Consider an exemplary use case where a prospective owner wants to verify a device, such as a vehicle, before taking ownership of the device. As shown in FIG. 3, during step 310, an owner of a device obtains one or more verifiable claims associated with the device (for example, issued by the manufacturer or supplier of the device and/or the constituent parts 220 of the device), for example by opening a settings console on the device to display a verifiable claim issued by the manufacturer or supplier of the device, for example, as a QR (Quick Response) code. Thus, the device may be a constituent part 220 or a manufactured device comprising multiple constituent parts 220.

The device owner then passes the scanned verifiable claims to an inspector-verifier during step 320, for example, by scanning a QR code with a mobile application to read the verifiable claim. For example, if the device is a manufactured device comprising multiple constituent parts 220, one or more of the multiple constituent parts 220 may each have a verifiable claim from the respective supplier. In some embodiments, the passing of the verifiable claims involves wrapping the verifiable claims inside of a data envelope, such as a JWT (JSON Web Token), which is then signed by the entity requesting the claims verification. In this manner, the entity presenting a verifiable claim can prove that the entity matches the entity that the verifiable claim was issued to.

The inspector-verifier 130 (for example, executing as part of the mobile application) then verifies a signature of the verifiable claim(s) during step 330, for example, by reading the public key of the manufacturer 210 (or supplier) from a DLT (e.g., the distributed ledger 240 of each part manufacturer 210, or supplier) and verifying the digital signature. In some embodiments, the inspector-verifier 130 is responsible for verifying the cryptographic signature, as well as understanding the trust relationship with the issuer 120 (e.g., a liquor store trusting the DMV issuer of a given state).

Now that a manufactured device has been provisioned in a way that is verifiable, verification of the manufactured device and its constituent parts can be performed instantaneously. When a manufacturer of a manufactured device, such as Tesla, is assembling disparate parts 220 together, for each verifiable part, the device manufacturer can query the distributed ledger 240 of the corresponding supplier using the verification process 300 of FIG. 3 to ensure that the part is genuine and/or defect free. Upon completing this process for all verifiable parts, the device manufacturer can then apply the part registration process 200 of FIG. 2 for the manufactured device to their newly manufactured device. The device manufacturer can generate a DID for the vehicle and register its public attributes (e.g., a vehicle identification number) on a DLT, such as a public DLT or a private DLT. While a car manufacturer, for example, can optionally build an application for vehicle owners that could access a private DLT, public DLTs work best in some embodiments because claims can be verified by anyone (a public ledger is often considered more open and reusable than a private DLT; however, a privately owned ledger can technically work, although the use of the private DLT would be scoped to only those entities that can access it).

The private key could then be stored within the device, such as on a trusted execution environment. The last step in this process is to capture the list of all the installed verifiable parts, for example, by issuing a verifiable claim that declares all of the verifiable parts that were installed. The verifiable claim would be issued by the device manufacturer and stored on the device. One advantage of using a verifiable claim here provides the benefit of ensuring data integrity.

Device/Part Recall

With the disclosed adaptive and verifiable device BOM infrastructure in place, device/part recalls, for example, can be quickly detected. The disclosed adaptive and verifiable device BOM infrastructure also facilitates new operational dynamics such as automatically preventing an owner from operating a device if a critical recall has occurred.

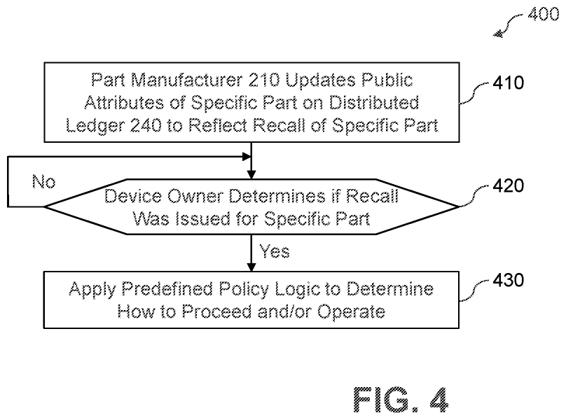

FIG. 4 is a flow chart illustrating an exemplary implementation of a part registry update process 400, according to some embodiments of the disclosure. In the example of FIG. 4, a part manufacturer 210 (or supplier) initially updates the public attributes of a specific part on their DLT during step 410 to reflect a recall of the specific part. A test is performed by the device comprising the specific part during step 420 to determine if a recall has been issued for the specific part. In this manner, the next time that the device performs the parts verification process 400, the recall would be detected.

If it is determined during step 420 that a recall has been issued for the specific part, then the device applies predefined recall policy logic during step 430 to determine how to proceed and/or operate. For example, for non-critical recalls, an alert can be displayed to the user. For critical recalls, the user could be restricted from operating the device. In a further variation, an OEM (original equipment manufacturer) can monitor DLTs of one or more part suppliers for recalls, and upon detecting a recall, the OEM can update the status of an issued verifiable claim (e.g., change status to a suspended state). When the device then attempted to verify the status of a parts claim, for example, using the part verification process 400, the device would detect the status change and take an appropriate action (e.g., implementing one or more predefined application policies).

Device BOM Updates

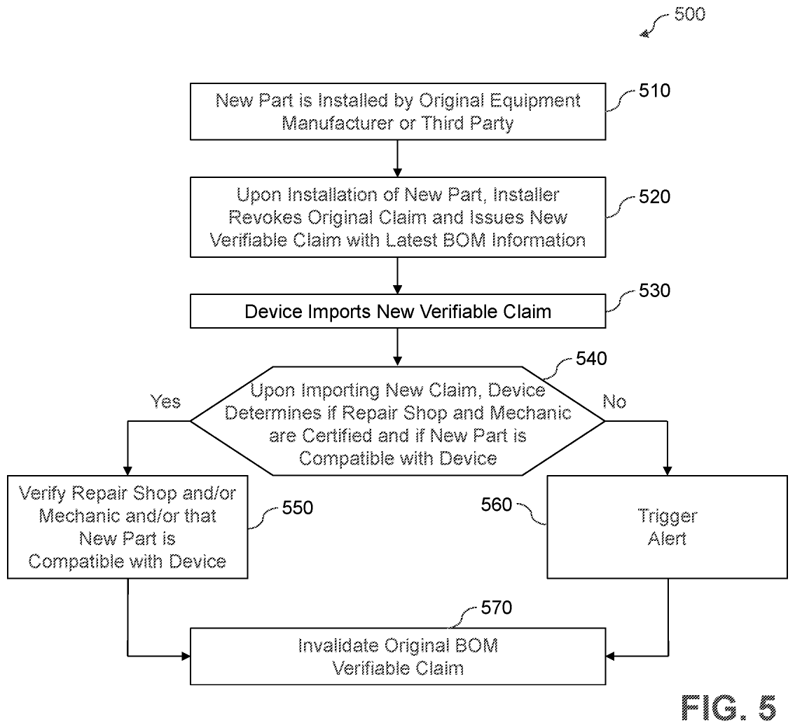

In some embodiments, the described adaptive and verifiable device BOM infrastructure allows new parts to be installed on a device in a cryptographically verifiable manner by the OEM or third parties. FIG. 5 is a flow chart illustrating an exemplary implementation of a device BOM update process 500, according to one or more embodiments. In the example of FIG. 5, when a new part is installed by an OEM or a third party during step 510, then, upon installation of the new part, the installer can revoke the original claim and issue a new claim with the latest BOM information during step 520. If a new part is installed by a third party, for example, then, upon installation, the service center could issue a new verifiable claim that cites:
the DID of the service center;
the DID of the mechanic; and
the DID of the part.

The device imports the new verifiable claim during step 530. Upon importing the new claim, the device determines if the repair shop and mechanic are certified and/or if the part is compatible with the device during step 540.

If it is determined during step 540 that the repair shop and/or mechanic are certified and/or that the part is compatible with the device, the device verifies the repair shop and mechanic and/or certifies that the part is compatible with the device during step 550. This verification could be done by the device, for example, by invoking calls to a server setup by the OEM. Another approach to perform this verification step would be for the OEM to issue verifiable claims to the third party repair shops and mechanics with a claim regarding their certification.

If it is determined during step 540 that the repair shop and/or mechanic are not certified and/or that the part is not compatible with the device, then an alert is triggered by the device during step 560.

Finally, the device invalidates the original BOM verifiable claim during step 570. In one or more embodiments, verifiable claims can have a status associated with them, e.g., suspended or revoked. In this case, the device could communicate with an OEM server and request that the status of the original claim is changed to revoked. The device could then request a new verifiable claim for the original parts that remain installed on the device. In a further variation of a verifiable claim reconciliation process, the OEM issues granular claims (e.g., one claim per part). This would simplify the part upgrade process and require simply revoking the original claim by the OEM. Lastly, if revocation was not possible on the device, the device could instead be instrumented to only accept the latest verification claim that was issued for the part.

Now consider that a part is updated in a fraudulent manner, such as:
a certified person installs an incompatible part;
an uncertified person installs a compatible part; and/or
an uncertified person installs an incompatible part

Given that the device can detect and inspect newly installed parts, a discrepancy between the verifiable BOM of the device and current hardware could be detected. Depending on the particular fraudulent use case, the device could take one or more predefined actions, for example, commensurate with the associated risk. For example, if an uncertified person installs a compatible part, then an alert could be shown to the device owner. If a critical part was installed by an uncertified person that is not compatible with the device, then the device could display a stark warning to the user and void the warranty if the user proceeds to operate the vehicle.

From a device auditing perspective, the device could also generate claims regarding an invalid state and persist them for the life of the device. This could be helpful, for example, in cases where the device is later sold to a third party.

One or more embodiments of the disclosure provide improved methods, apparatus and computer program products for generating adaptive and verifiable device BOMs. The foregoing applications and associated embodiments should be considered as illustrative only, and numerous other embodiments can be configured using the techniques disclosed herein, in a wide variety of different applications.

In some embodiments, the disclosed adaptive and verifiable device BOM techniques provide for a secure on-boarding of IOT devices, which is often an ongoing challenge for the industry. The basic model used by some vendors is based on the cryptographic keys that are inserted by the manufacturer during the manufacturing process and then verified during the on-boarding process (i.e., modeled after the traditional Smart Card “transport certificate” approach). This method is not flexible enough to accommodate complex Industrial IOT (HOT) assets consisting of many components from disparate suppliers and is limited to the onboarding phase of the asset life cycle. The disclosed adaptive and verifiable device BOM solution offers a more flexible solution.

For many IOT devices, the functional safety of the device is a paramount consideration. A typical industrial asset may stay in service for 25-30 years, for example. Long after a trustworthy asset has been securely validated and onboarded, it is important to ensure that the device continues to operate safely. Among many safety factors, one is the integrity of the components comprising that asset, including changes due to repair/replacement and/or aftermarket upgrades that inevitably happen during the long life cycle of the asset. The disclosed adaptive and verifiable device BOM solution provides an adaptive and secure approach that considers such changes/upgrades in the field.

Modern asset management techniques rely on analytics based on asset metadata and other information for use cases such as predictive maintenance and asset prioritization. A reliable source of asset metadata is essential for these applications. In one or more embodiments, the disclosed adaptive and verifiable device BOM techniques define a technique for generating verifiable device metadata.

Consider a manufacturer that detects owners using unauthorized aftermarket parts. The use of aftermarket parts creates a liability concern for manufacturers, as well as loss of revenue for OEMs. The disclosed adaptive and verifiable device BOM techniques provide a reliable method for detecting the use of unauthorized parts for safety-sensitive components of their manufactured products, such as vehicles (e.g., brakes and steering components). In addition, disclosed adaptive and verifiable device BOM techniques provide a cryptographically secure mechanism for tracking high-value components in products, such as a battery pack.

Consider an asset owner that detects the use of unauthorized parts by a maintenance staff. In this use case, an honest asset owner is a victim of fraud, when a maintenance shop is using low-quality aftermarket parts to replace the sensitive components of their asset. One or more embodiments of the disclosed adaptive and verifiable device BOM techniques can detect such a case.

It should also be understood that the disclosed adaptive and verifiable device BOM techniques, as described herein, provide assurances that (i) one or more components of a device are genuine parts according to one or more predefined specifications by the manufacturer, and/or (ii) that the one or more components of the device are defect free.

One or more embodiments of the disclosure provide improved methods, apparatus and computer program products for providing and verifying adaptive and verifiable bills of materials. The foregoing applications and associated embodiments should be considered as illustrative only, and numerous other embodiments can be configured using the techniques disclosed herein, in a wide variety of different applications.

It should also be understood that the disclosed adaptive and verifiable bill of materials techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for providing and verifying adaptive and verifiable bills of materials may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a Platform-as-a-Service (PaaS) offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based bill of materials verification engine, or portions thereof, are illustratively implemented for use by tenants of such a multi-tenant environment.

Cloud infrastructure as disclosed herein can include cloud-based systems such as Amazon Web Services (AWS), Google Cloud Platform (GCP) and Microsoft Azure. Virtual machines provided in such systems can be used to implement at least portions of a cloud-based bill of materials verification engine platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

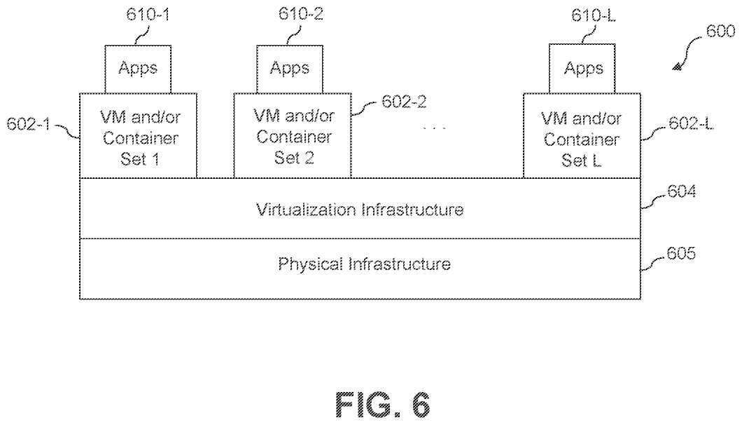

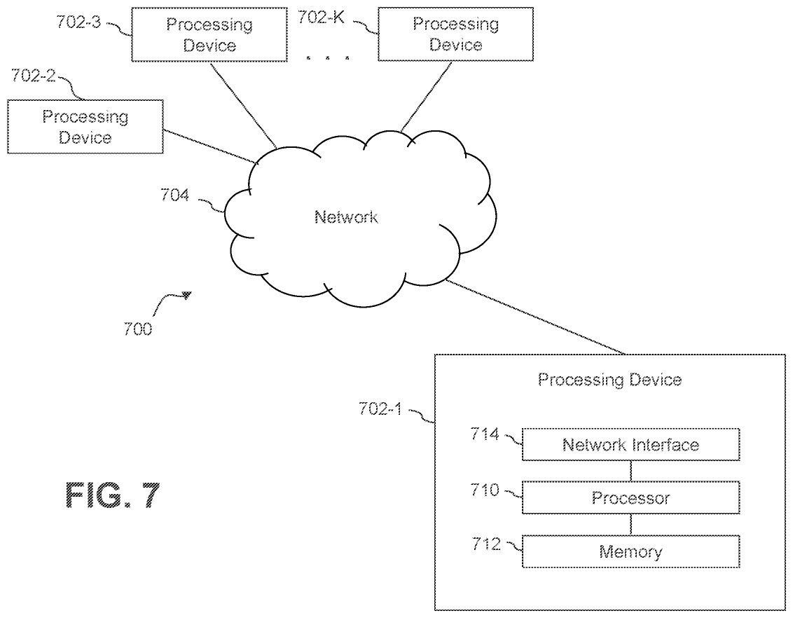

Illustrative embodiments of processing platforms will now be described in greater detail with reference to FIGS. 6 and 7. These platforms may also be used to implement at least portions of other information processing systems in other embodiments.

FIG. 6 shows an example processing platform comprising cloud infrastructure 600. The cloud infrastructure 600 comprises a combination of physical and virtual processing resources that may be utilized to implement at least a portion of an information processing system. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 may comprise respective VMs, respective sets of one or more containers, or respective sets of one or more containers running in VMs.

In some implementations of the FIG. 6 embodiment, the VMs/container sets 602 comprise respective VMs implemented using virtualization infrastructure 604 that comprises at least one hypervisor. Such implementations can provide bill of materials verification functionality of the type described above for one or more processes running on a given one of the VMs. For example, each of the VMs can implement bill of materials verification control logic and associated verifiable claim evaluation logic for providing verifiable bill of materials functionality for one or more processes running on that particular VM.

An example of a hypervisor platform that may be used to implement a hypervisor within the virtualization infrastructure 604 is the VMware® vSphere® which may have an associated virtual infrastructure management system such as the VMware® vCenter™. The underlying physical machines may comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system. Such implementations can provide bill of materials verification functionality of the type described above for one or more processes running on different ones of the containers. For example, a container host device supporting multiple containers of one or more container sets can implement one or more instances of bill of materials verification control logic and associated verifiable claim evaluation logic for providing verifiable bill of materials functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises at least a portion of the given system and includes a plurality of processing devices, denoted 702-1, 702-2, 702-3, . . . 702-K, which communicate with one another over a network 704. The network 704 may comprise any type of network, such as a wireless area network (WAN), a local area network (LAN), a satellite network, a telephone or cable network, a cellular network, a wireless network such as WiFi or WiMAX, or various portions or combinations of these and other types of networks.

The processing device 702-1 in the processing platform 700 comprises a processor 710 coupled to a memory 712. The processor 710 may comprise a microprocessor, a microcontroller, an application specific integrated circuit (ASIC), a field programmable gate array (FPGA) or other type of processing circuitry, as well as portions or combinations of such circuitry elements, and the memory 712, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 6 or 7, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure such as VxRail™, VxRack™, VxBlock™, or Vblock® converged infrastructure commercially available from Dell EMC.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining at least one verifiable claim associated with a device issued by at least one supplier of the device, wherein the at least one verifiable claim comprises a decentralized identity for the device with one or more corresponding public attributes; and
verifying the at least one verifiable claim for the device using the decentralized identity for the at least one verifiable claim and one or more of the corresponding public attributes obtained from a distributed ledger.

2. The method of claim 1, wherein the verifying comprises reading a public key from the distributed ledger and verifying a digital signature of the verifiable claim using the public key.

3. The method of claim 1, wherein the at least one verifiable claim provides one or more of an assurance that the device is a genuine part according to one or more specifications by the manufacturer and an assurance that the device is defect free.

4. The method of claim 1, wherein the device comprises one or more of a constituent part and a manufactured device comprising a plurality of constituent parts.

5. The method of claim 1, wherein the at least one verifiable claim for a given part is created by one or more of a manufacturer and a supplier of the given part registering a decentralized identity for the given part with the one or more corresponding public attributes with the distributed ledger.

6. The method of claim 5, wherein the at least one verifiable claim for the given part comprises one or more of a part serial number; a part creation date; a part provisioned date; quality assurance data; warranty expiration data; and a part status.

7. The method of claim 6, wherein the part status of the given part indicates a recalled status, and wherein one or more predefined recall policies are applied for one or more of the given part having the recalled status and a device comprising the given part having the recalled status.

8. The method of claim 1, wherein, upon an installation of a new version of a given part in the device, a verifiable claim for a prior version of the given part is revoked; a new verifiable claim is issued for the new version of the given part claim; and a determination is made to determine whether one or more of: (i) one or more of the repair shop and an installer are certified, and (ii) the new version of the given part is compatible with the device.

9. The method of claim 9, wherein an audit log for the device records when the one or more of: (i) the one or more of the repair shop and an installer are not certified, and (ii) the new version of the given part is not compatible with the device.

10. A computer program product, comprising a tangible machine-readable storage medium having encoded therein executable code of one or more software programs, wherein the one or more software programs when executed by at least one processing device perform the following steps:
obtaining at least one verifiable claim associated with a device issued by at least one supplier of the device, wherein the at least one verifiable claim comprises a decentralized identity for the device with one or more corresponding public attributes; and
verifying the at least one verifiable claim for the device using the decentralized identity for the at least one verifiable claim and one or more of the corresponding public attributes obtained from a distributed ledger.

11. The computer program product of claim 10, wherein the verifying comprises reading a public key from the distributed ledger and verifying a digital signature of the verifiable claim using the public key.

12. The computer program product of claim 10, wherein the at least one verifiable claim for a given part is created by one or more of a manufacturer and a supplier of the given part registering a decentralized identity for the given part with the one or more corresponding public attributes with the distributed ledger.

13. The computer program product of claim 12, wherein the at least one verifiable claim for the given part comprises a part status and wherein the part status of the given part indicates a recalled status, and wherein one or more predefined recall policies are applied for one or more of the given part having the recalled status and a device comprising the given part having the recalled status.

14. The computer program product of claim 10, wherein, upon an installation of a new version of a given part in the device, a verifiable claim for a prior version of the given part is revoked; a new verifiable claim is issued for the new version of the given part claim; and a determination is made to determine whether one or more of: (i) one or more of the repair shop and an installer are certified, and (ii) the new version of the given part is compatible with the device.

15. The computer program product of claim 14, wherein an audit log for the device records when the one or more of: (i) the one or more of the repair shop and an installer are not certified, and (ii) the new version of the given part is not compatible with the device.

16. An apparatus, comprising:
a memory; and
at least one processing device, coupled to the memory, operative to implement the following steps:
obtaining at least one verifiable claim associated with a device issued by at least one supplier of the device, wherein the at least one verifiable claim comprises a decentralized identity for the device with one or more corresponding public attributes; and
verifying the at least one verifiable claim for the device using the decentralized identity for the at least one verifiable claim and one or more of the corresponding public attributes obtained from a distributed ledger.

17. The apparatus of claim 16, wherein the verifying comprises reading a public key from the distributed ledger and verifying a digital signature of the verifiable claim using the public key.

18. The apparatus of claim 16, wherein the at least one verifiable claim for a given part is created by one or more of a manufacturer and a supplier of the given part registering a decentralized identity for the given part with the one or more corresponding public attributes with the distributed ledger.

19. The apparatus of claim 18, wherein the at least one verifiable claim for the given part comprises a part status and wherein the part status of the given part indicates a recalled status, and wherein one or more predefined recall policies are applied for one or more of the given part having the recalled status and a device comprising the given part having the recalled status.

20. The apparatus of claim 16, wherein, upon an installation of a new version of a given part in the device, a verifiable claim for a prior version of the given part is revoked; a new verifiable claim is issued for the new version of the given part claim; and a determination is made to determine whether one or more of: (i) one or more of the repair shop and an installer are certified, and (ii) the new version of the given part is compatible with the device.
